(19) United States
(12) Patent Application Publication
(10) Pub. No.: US 2021/0297748 A1
(43) Pub. Date: Sep. 23, 2021

(54) METHOD FOR MANAGING MISSION CRITICAL VIDEO (MCVIDEO) COMMUNICATIONS IN OFF-NETWORK MCVIDEO COMMUNICATION SYSTEM

(71) Applicant: Samsung Electronics Co., Ltd., Suwon-si, Gyeonggi-do (KR)

(72) Inventor: Nishant GUPTA, Bangalore (IN)

(21) Appl. No.: 16/337,640

(22) PCT Filed: Sep. 29, 2017
(86) PCT No.: PCT/KR2017/010951

§ 371 Date: Mar. 28, 2019

(30) Foreign Application Priority Data
Oct. 1, 2016 (IN) 2016 41033646
Sep. 28, 2017 (IN) 201641033646

(51) Int. Cl. H04N 21/63; H04N 21/4363; H04N 21/436

(52) U.S. Cl. CPC H04N 21/632; H04N 21/43615; H04N 21/43637

(57) ABSTRACT

Embodiments herein provide systems and methods for off-network Mission Critical Video (MCVideo) communications by one or more MCVideo devices in off-network MCVideo communication system. The method includes transmitting, by a first MCVideo device, a communication request message with an indication to one or more second MCVideo devices. The method includes receiving, by the first MCVideo device, a communication answer response message from one or more second MCVideo devices. Further, the method includes establishing, by the first MCVideo device, a media session for video communication with one or more second MCVideo devices. Furthermore, the method includes communicating, by one of the first MCVideo device and a second MCVideo device, the video to one or more MCVideo devices.

### CROSS-REFERENCE TO RELATED APPLICATION(S)

This application is a U.S National Stage application under 35 U.S.C. § 371 of an International application number PCT/KR2017/010951, filed on Sep. 29, 2017, and claims priority of an Indian patent application number 201641033646, and 201641033646, filed on Oct. 1, 2016 and Sep. 28, 2017, in the Indian Intellectual Property Office, the disclosure of which is incorporated by reference herein in its entirety.

### TECHNICAL FIELD

The embodiment herein generally relates to Mission Critical Video (MCVideo) communications and more particularly relates to a method for managing MCVideo communications in off-network MCVideo communication system. The present application is based on, and claims priority from an Indian Application Number 201641033646 filed on 1 Oct. 2016, the disclosure of which is hereby incorporated by reference herein.

### BACKGROUND ART

Public safety networks are used for Mission Critical (MC) Data/Voice/Video communications. The MC communication may include defined set of MC services. Such MC services typically build on existing third generation partnership project (3GPP) transport communication mechanisms provided by the evolved packet system (EPS) architectures to establish, maintain, and terminate the actual communication path(s) among the users. The MCVideo defines a service for MCVideo communications. Typically, a MCVideo server provides centralized support for such MCVideo communications. The MCVideo server can facilitate or govern MCVideo communications among various users part of the network.

In an alternate deployment, such MCVideo services can be off-network. In such deployments, the MCVideo devices communicate directly with each other without the MCVideo server for centralized support for the service.

The off-network MCVideo Pull and MCVideo Push leverage the Device-to-Device (D2D) communication capabilities of MCVideo devices to enable the ability to communicate using videos (i.e., either live or recorded), off the infrastructure network.

MCVideo Pull is the capability to pull a video from a source, which may be a user equipment (UE) in the field or a video storage server. This service enables a MCVideo user to request another MCVideo user or a MCVideo client to transmit a stored video or a video directly taken from a camera unit.

MCVideo Push is a similar capability to push a video directly taken from a camera unit or a video received by a MCVideo user or MCVideo client from another MCVideo client to a third MCVideo group or MCVideo client. This service enables a MCVideo user to remotely show another entity, the video that is being received or recorded. In light of the above context, various methods to support MCVideo communications and its associated features are necessary for effective MCVideo communication among the MCVideo devices.

The above information is presented as background information only to help the reader to understand the present invention. Applicants have made no determination and make no assertion as to whether any of the above might be applicable as prior art with regard to the present application.

### DISCLOSURE OF INVENTION

### Solution to Problem

The principal object of the embodiments herein is to provide a method for managing Mission Critical Video (MCVideo) communications in off-network MCVideo communication system.

Another object of the embodiments herein is to provide a method for off-network MCVideo pull from one or more MCVideo devices.

Another object of the embodiments herein is to provide a method for off-network MCVideo push to one or more MCVideo devices.

Another object of the embodiments herein is to provide a method for off-network MCVideo push to one or more MCVideo devices based on a remote video push request message from a MCVideo device.

Another object of the embodiments herein is to provide a method for establishing a MCVideo group communication for MCVideo communication.

Another object of the embodiments herein is to provide a method for off-network MCVideo push to a group of MCVideo devices based on a remote video push request message from a MCVideo device.

Accordingly the embodiments herein provide a method for managing Mission Critical Video (MCVideo) communications by one or more MCVideo devices in off-network MCVideo communication system. The method includes transmitting, by a first MCVideo device, a communication request message with an indication to one or more second MCVideo devices. The method includes receiving, by the first MCVideo device, a communication answer response message from one or more second MCVideo devices. Further, the method includes establishing, by the first MCVideo device, a media session for video communication with one or more second MCVideo devices. Furthermore, the method includes communicating, by one of the first MCVideo device and second MCVideo device, the video to one or more MCVideo devices.

In an embodiment, a private communication request message is transmitted to one or more second MCVideo devices with a video pull indication to pull a video from one or more second MCVideo devices.

In an embodiment, the video is communicated from one or more second MCVideo devices to the first MCVideo device after establishing the media session between the first MCVideo device and one or more second MCVideo devices.

In an embodiment, a private communication request message is transmitted to one or more second MCVideo devices with a video push indication to push a video to one or more second MCVideo devices.

In an embodiment, the video is communicated from the first MCVideo device to one or more second MCVideo devices after establishing the media session between the first MCVideo device and one or more second MCVideo devices.

In an embodiment, the video being communicated to one or more second MCVideo devices is one of recorded live video on the first MCVideo device and a video received by the first MCVideo device from a third MCVideo device.

In an embodiment, the first MCVideo device transmits a video push notification message to the third MCVideo device, wherein the video push notification message indicates that the video being received from the third MCVideo device is being pushed to one or more second MC devices.

In an embodiment, the private communication request message with a video push indication is transmitted to one or more second MCVideo devices by the first MCVideo device, in response to a remote video push request message received from a third MCVideo device.

In an embodiment, a video push trying response message is transmitted to the third MCVideo device by the first MCVideo device in response to the remote video push request message. The video push trying response message indicates that the first MCVideo device is trying to establish communication with one or more second MCVideo devices.

In an embodiment, a video push notification message is transmitted to the third MCVideo device by the first MCVideo device, after the communication is established with one or more second MCVideo devices, wherein the video push notification message indicates that the video is being pushed to one or more second MCVideo devices.

In an embodiment, a group communication request message is transmitted by the first MCVideo device to a MCVideo group of one or more second MCVideo devices with a video push indication to push a video from the first MCVideo device to the MCVideo group of one or more second MCVideo devices.

In an embodiment, the video is communicated from the first MCVideo device to the MCVideo group of one or more second MCVideo devices after establishing the media session between the MCVideo devices. The video being communicated to one or more second MCVideo devices is one of a recorded live on the first MCVideo device or a video received by the first MCVideo device from a third MCVideo device.

In an embodiment, the group communication request message with a video push indication is transmitted to a MCVideo group of one or more second MCVideo devices by the first MCVideo device, in response to a remote video push request message received from a third MCVideo device.

Accordingly the embodiments herein provide a first Mission Critical Video (MCVideo) device for managing MCVideo communications in off-network MCVideo communication system. The first MCVideo device includes a MCVideo manager configured to transmit a communication request message with an indication to one or more second MCVideo devices. The MCVideo manager configured to receive a communication answer response message from one or more second MCVideo devices. Further, the MCVideo manager configured to establish a media session for video communication with one or more second MCVideo devices. Furthermore, the MCVideo manager configured to communicate the video to one or more MCVideo devices.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The embodiments herein will be better understood from the following detailed description with reference to the drawings, in which:

FIGS. 1A-1D illustrate example off-network MCVideo communication systems for managing MCVideo communication, according to an embodiment as disclosed herein;

FIG. 2 is a block diagram illustrating various hardware components of a MCVideo device, according to an embodiment as disclosed herein;

FIG. 3 is a flow diagram illustrating a method for managing MCVideo communications by one or more MCVideo devices in the off-network MCVideo communication system;

FIG. 4 is a sequence diagram illustrating various signaling messages exchanged between a first MCVideo device and a second MCVideo device, for pulling a video from the second MCVideo device(s), according to the embodiment as disclosed herein;

FIG. 5 is a sequence diagram illustrating various signaling messages exchanged between the first MCVideo device, the second MCVideo device and a third MCVideo device, where the first MCVideo device is pushing a video towards the second MCVideo device, according to an embodiment as disclosed herein;

FIG. 6 is a sequence diagram illustrating various signaling messages exchanged between the first MCVideo device, the second MCVideo device and the third MCVideo device, where the first MCVideo device is pushing a video towards the second MCVideo device based on a request from the third MCVideo device, according to an embodiment as disclosed herein;

FIG. 7 is a sequence diagram illustrating various signaling messages exchanged between one or more MCVideo devices for MCVideo group communication setup, according to an embodiment as disclosed herein;

FIG. 8 is a sequence diagram illustrating various signaling messages exchanged between the first MCVideo device, the third MCVideo device and a group of second MCVideo devices for pushing the video to the a group of second MCVideo devices, according to an embodiment as disclosed herein;

FIG. 9 is a sequence diagram illustrating various signaling messages exchanged between the first MCVideo device and the second MCVideo device, where the first MCVideo device is pulling a video from the second MCVideo device, according to an embodiment as disclosed herein;

FIG. 10 is a sequence diagram illustrating various signaling messages exchanged between the first MCVideo device, the second MCVideo device and the third MCVideo device, where the first MCVideo device is pulling a video towards itself and the third MCVideo device from the second MCVideo device, according to an embodiment as disclosed herein;

FIG. 11 is another sequence diagram illustrating various signaling messages exchanged between the first MCVideo device, the second MCVideo device and the third MCVideo device, where the first MCVideo device is pulling a video towards itself and the third MCVideo device pulls the video from the second MCVideo device, according to an embodiment as disclosed herein;

FIG. 12 is a sequence diagram illustrating various signaling messages exchanged between the first MCVideo device, the second MCVideo device and the third MCVideo device, where the first MCVideo device is pulling a video towards itself and the third MCVideo device is pulling the video from the second MCVideo device, according to an embodiment as disclosed herein;

FIG. 13 is a sequence diagram illustrating various signaling messages exchanged between the first MCVideo device, the second MCVideo device and a MCVideo group, where the first MCVideo device is pulling a video towards the MCVideo group from the second MCVideo device, according to an embodiment as disclosed herein;

FIG. 14 is a sequence diagram illustrating various signaling messages exchanged between the first MCVideo device, the second MCVideo device and the MCVideo group, where the first MCVideo device A is pulling a video towards itself and the MCVideo group from the second MCVideo device, according to an embodiment as disclosed herein;

FIG. 15 is a sequence diagram illustrating various signaling messages exchanged between the first MCVideo device, the second MCVideo device and the MCVideo group, where the first MCVideo device is pushing a video towards MCVideo group, according to an embodiment as disclosed herein; and

FIG. 16 is a sequence diagram illustrating various signaling messages exchanged between the first MCVideo device, the second MCVideo device and the third MCVideo device, where the second MCVideo device is receiving a video from the third MCVideo device, which is being pulled by the first MCVideo device, according to an embodiment as disclosed herein.

### MODE FOR THE INVENTION

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments. Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The term “first”, “second” and “Third” herein are used merely for labeling purpose and can be used interchangeably without departing from the scope of the embodiments.

Accordingly the embodiments herein provide systems and methods for managing Mission Critical Video (MCVideo) communications by one or more MCVideo devices in a MCVideo communication system. The method includes transmitting, by a first MCVideo device, a communication request message with an indication to one or more second MCVideo devices. The method includes receiving, by the first MCVideo device, a communication answer response message from one or more second MCVideo devices. Further, the method includes establishing, by the first MCVideo device, a media session for video communication with one or more second MCVideo devices. Furthermore, the method includes communicating, by one of the first MCVideo device and second MCVideo device, the video to one or more MCVideo devices.

The proposed method provides a mechanism for off-network MCVideo communication among the MCVideo devices. The proposed method can be used to initiate a one-way communication with another MCVideo device in off-network and to pull a video from another MCVideo device. The proposed method allows a one-way communication with another MCVideo device in the off-network to push a video stream to another MCVideo device.

Further, the proposed method allows the MCVideo device to push a video stream to another MCVideo device, which is being received by yet another MCVideo device. Furthermore, the proposed method allows a MCVideo device to request another MCVideo device to push a video stream to one or more MCVideo devices in a MCVideo group, thereby facilitating a group communication.

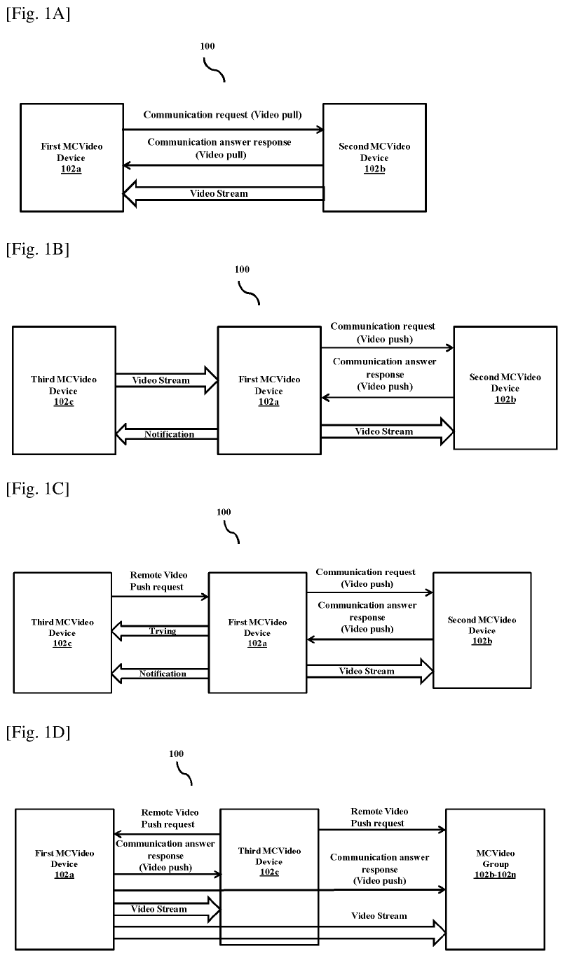

Referring now to the drawings, and more particularly to FIGS. 1 through 16, where similar reference characters denote corresponding features consistently throughout the figures, there are shown preferred embodiments.

FIGS. 1A-1D illustrate example off-network MCVideo communication systems for managing MCVideo communication, according to an embodiment as disclosed herein. In off-network MCVideo communication systems, the MCVideo devices communicate directly with each other without a server for centralized support for the MCVideo service.

In an embodiment, the MCVideo devices can be for e.g., an electronic device, a User Equipment (UE), a drone, an image or a video capturing apparatus, any other electronic device capable of supporting MCVideo communication or the like. Each of the MCVideo devices 102a-102n can include a MCVideo client (i.e., an application) for communicating with the other MCVideo device The first MCVideo device 102a includes a first MCVideo client or a MCVideo client A; the second MCVideo device 102b includes a second MCVideo client or a MCVideo client B; the third MCVideo device 102c includes a third MCVideo client or a MCVideo client C and so on.

The MCVideo client residing at each of the MCVideo devices 102a-102n, acts as user agent for all the MCVideo communications.

Referring to the FIG. 1A, the off-network MCVideo communication system 100 includes a first MCVideo device 102a and a second MCVideo device 102b. Initially, the first MCVideo device 102a sends a communication request message to pull video from the second MCVideo device 102a. The MCVideo user of the second MCVideo device 102b is notified of the video pull request from the first MCVideo device 102a. The second MCVideo device 102b responds with a communication answer response message. Further, the MCVideo user of the first MCVideo device 102a is notified about the communication answer response message from the second MCVideo device 102b. The first MCVideo device 102a and the second MCVideo device 102b establish a media plane (i.e., a media session) and the video stream is transmitted from the second MCVideo device 102b to the first MCVideo device 102a as shown in the FIG. 1A. Although only one second MCVideo device 102b is shown in the FIG. 1A, it is to be noted that there can be more number of second MCVideo devices 102b-102n from which the first MCVideo device 102a can pull the video by transmitting the communication request message with video pull indication.

Referring to the FIG. 1B, the off-network MCVideo communication system 100 includes a first MCVideo device 102a, a second MCVideo device 102b and a third MCVideo device 102c. Initially, the first MCVideo device 102a sends a communication request (i.e., a MCVideo Push request) to push the video being received from the third MCVideo device 102c to the second MCVideo device 102b. The second MCVideo device 102b is notified of the MCVideo Push request from the first MCVideo device 102a. The second MCVideo device 102b sends a communication response responds with a communication answer message to the first MCVideo device. After receiving the communication answer response for video push from the second MCVideo device 102b, a notification to indicate the video push is sent to the third MCVideo device 102c. Further, the media plane is established between the first MCVideo device 102a and the second MCVideo device 102b to share the video stream from the third MCVideo device 102c. Although only one second MCVideo device 102b is shown in the FIG. 1B, it is to be noted that there can be more number of second MCVideo devices 102b-102n to which the video can be pushed by transmitting the communication request message to one or more second MCVideo devices 102b-102n.

Referring to the FIG. 1C, the off-network MCVideo communication system 100 includes a first MCVideo device 102a, a second MCVideo device 102b and a third MCVideo device 102c. Initially, the third MCVideo device 102c sends a remote video push request towards the first MCVideo device 102a. The remote video push request indicates the second MCVideo device 102b as the intended recipient. The first MCVideo device 102a notifies the MCVideo user of the first MCVideo device 102a about the incoming video push request. The first MCVideo device 102a, if required, enables ProSe layer to discover the second MCVideo device 102b. The first MCVideo device 102a sends a trying response to the third MCVideo device 102c indicating that communication is being established with the second MCVideo device 102b. The first MCVideo device 102a sends a communication request with video push indication to the second MCVideo device 102b. The communication request with video push indication may indicate that the request was in response to the video push request from the the third MCVideo device 102c.

The second MCVideo device 102b sends a communication answer response to the first MCVideo device 102a in response to the communication request. After receiving the communication answer response from the second MCVideo device 102b, the first MCVideo device 102a sends a notification message to the third MCVideo device 102c indicating that the second MCVideo device 102b has accepted the communication request. The first MCVideo device 102a and the second MCVideo device 102b establish the media plane for MCVideo communication and the video is communicated from the first MCVideo device 102a to the second MCVideo device 102b.

Referring to the FIG. 1D, the off-network MCVideo communication system 100 includes a first MCVideo device 102a, a third MCVideo device 102c and a MCVideo group 102b-102n. The FIG. 1D describes the procedure to establish a MCVideo group communication with other MCVideo devices of the MCVideo group. Initially, the third MCVideo device 102c sends a remote video push request towards the MCVideo group of second MCVideo devices 102b-102n and to the first MCVideo device 102a. The MCVideo users of the MCVideo group of second MCVideo devices 102b-102n are notified about the video push request from first MCVideo device 102a.

The first MCVideo device 102a responds a communication answer response with video push indication message to the third MCVideo device 102c. Further, the third MCVideo device 102c sends the communication answer response message to the MCVideo group second MCVideo devices 102b-102n. The video stream is pushed from the first MCVideo device 102a to the MCVideo group of second MCVideo devices.

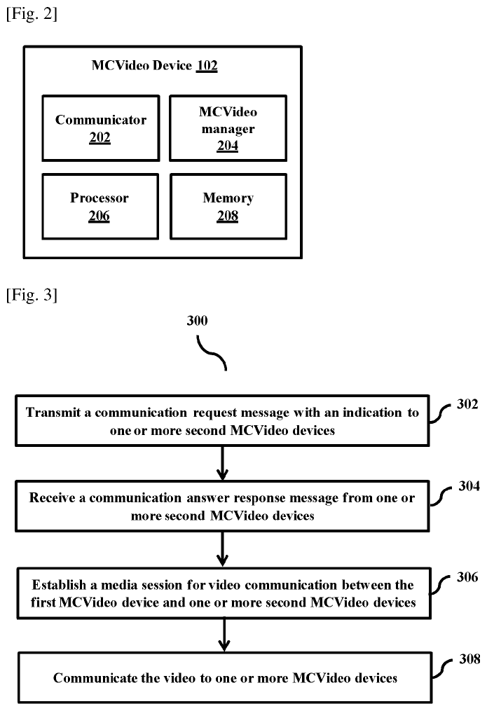

FIG. 2 is a block diagram illustrating various hardware components of a MCVideo device 102, according to an embodiment as disclosed herein. The MCVideo device 102 can be a first MCVideo device 102a, a second MCVideo device 102b, a third MC Video device 102c or any other MCVideo device.

As depicted in the FIG. 2, the MCVideo device 102 includes a communicator 202, a MCVideo manager 204, a processor 206 and memory 208.

It should be noted that each of the MCVideo device i.e., the first MCVideo device 102a, the second MCVideo device 102b, the third MC Video device 102c and so on can have the communicator 202, a MCVideo manager 204, a processor 206 and memory 208 respectively for managing MCVideo communications among one or more MCVideo devices in the MCVideo communication system 100.

The communicator 202 can be configured to discover one or more MCVideo devices in proximity of the MCVideo device 102 using existing Proximity Service (ProSe) Discovery procedures. The communicator 202 can be configured to perform a search or a scan for identifying or discovering one or more MCVideo devices in proximity. Further, the communicator can be configured to exchange one or more signaling messages with one or more MCVideo devices during discovery of the MCVideo devices and to initiate video communication with one or more MCVideo devices.

In an embodiment, the MCVideo manager 204 can be configured to transmit a communication request message with an indication to one or more MCVideo devices (i.e., to the second MCVideo devices 102b-102n and so on). The MCVideo manager 204 can be configured to receive a communication answer response message from one or more MCVideo devices. Further, the MCVideo manager 204 can be configured to establishing a media session for video communication with one or more MCVideo devices. Furthermore, the MCVideo manager 204 can be configured to communicate the video to one or more MCVideo devices.

In an embodiment, the MCVideo manager 204 can be configured to transmit a private communication request message with a video pull indication to one or more MCVideo devices (i.e., second MCVideo devices 102b-102n) with a video pull indication to pull a video from one or more second MCVideo devices. Further, the MCVideo manager 204 can be configured to establish a media session with one or more MCVideo devices for pulling the video from one or more MCVideo devices.

In an embodiment, the MCVideo manager 204 can be configured to transmit a private communication request message with a video push indication one or more MCVideo devices to push the video to one or more MCVideo devices. Further, the MCVideo manager 204 can be configured to establish a media session with one or more second MCVideo devices to communicate or to push the video to one or more MCVideo devices. The video pushed to one or more MCVideo devices can be a recorded live video on the MCVideo device 102 or a video received by the MCVideo device 102 from another MCVideo device, i.e., a third MCVideo device 102c.

In an embodiment, the MCVideo manager 204 can be configured to transmit a private communication request message with a video push indication to one or more MCVideo devices (i.e., one or more second MCVideo devices 102b-102n), in response to a remote video push request message received from another MCVideo device (i.e., a third MCVideo device 102c). Further, the MCVideo manager 204 can be configured to transmit a video push trying response message to another MCVideo device (i.e., the third MCVideo device) in response to the private communication request message with a video push indication after establishing the communication with MCVideo devices.

In an embodiment, the MCVideo manager 204 can be configured to transmit a group communication request with a video push indication to push a video from the MCVideo device 102 to the MCVideo group of one or more MCVideo devices.

In an embodiment, the group communication request message with a video push indication is transmitted to a MCVideo group of MCVideo devices in response to a remote video push request message received from another MCVideo device i.e., third MCVideo device 102c.

In an embodiment, the processor 206 (for example; a hardware unit, an apparatus, a Central Processing Unit (CPU), a Graphics Processing Unit (GPU), etc.,) communicatively coupled to a memory 208 (e.g., a volatile memory and/or a non-volatile memory); the memory 208 includes storage locations configured to be addressable through the processor 206.

In an embodiment, the memory 208 can be configured to store the Videos being recorded live on the MCVideo device 102 and the videos received from one or more second MCVideo devices 102b-102n and the third MCVideo device 102c. The memory 208 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 208 may, in some examples, be considered a non-transitory storage medium. The term “non-transitory” may indicate that the storage medium is not embodied in a carrier wave or a propagated signal. However, the term “non-transitory” should not be interpreted that the memory 208 is non-movable. In some examples, the memory 208 can be configured to store larger amounts of information than the memory. In certain examples, a non-transitory storage medium may store data that can, over time, change (e.g., in Random Access Memory (RAM) or cache).

Although the FIG. 2 shows the hardware components of the MCVideo device 102 but it is to be understood that other embodiments are not limited thereon. In other embodiments, the MCVideo device 102 may include less or more number of components. Further, the labels or names of the components are used only for illustrative purpose and does not limit the scope of the invention. One or more components can be combined together to perform same or substantially similar function to establish the data communication in the off-network MCVideo communication system 100.

FIG. 3 is a flow diagram 300 illustrating a method for managing MCVideo communications by one or more MCVideo devices in the off-network MCVideo communication system 100. The various operations or steps in the flow diagram 300 are performed by the MCVideo manager 204 in the MCVideo device 102.

At step 302, the method includes transmitting a communication request message with an indication to one or more second MCVideo devices 102b-102n.

At step 304, the method includes receiving a communication answer response message from one or more second MCVideo devices 102b-102n.

At step 306, the method includes establishing a media session for video communication between the first MCVideo device and one or more second MCVideo devices 102b-102n.

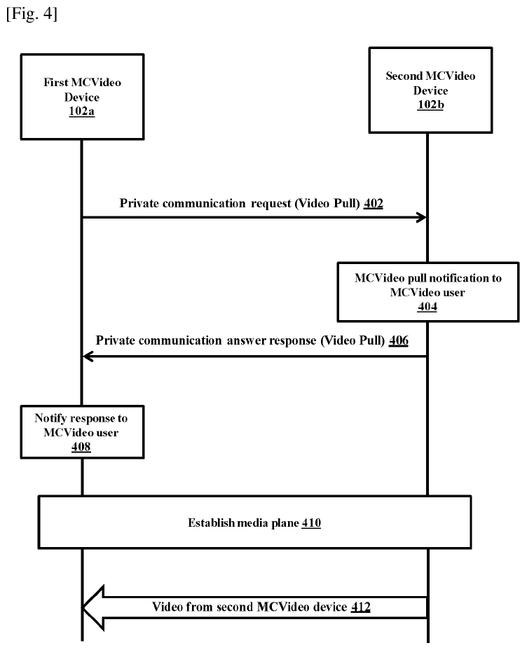

At step 308, the method includes communicating the video to one or more MCVideo devices. The various procedures managing the MCVideo communications (i.e., off-network video pull, video push, remotely initiated video push and remotely initiated video push to a group of MCVideo devices) are described in conjunction with FIGS. 4 through 16.

The various actions, acts, blocks, steps, or the like in the flow diagram 300 may be performed in the order presented, in a different order or simultaneously. Further, in some embodiments, some of the actions, acts, blocks, steps, or the like may be omitted, added, modified, skipped, or the like without departing from the scope of the invention.

FIG. 4 is a sequence diagram illustrating various signaling messages exchanged between a first MCVideo device and a second MCVideo device, for pulling a video from the second MCVideo device(s), according to the embodiment as disclosed herein.

The FIG. 4 describes procedures for the off-network MCVideo video pull, initiated by the first MCVideo device 102a to pull a video to from the second MCVideo device 102b.

The MCVideo client at the second MCVideo device can be an autonomous MCVideo client or can be a human controlled MCVideo client. The following are the pre-conditions for the off-network MCVideo video pull.

1. The MCVideo user at the first MCVideo device 102a has initiated MCVideo video pull with the second MCVideo device 102b.

2. The first MCVideo device 102a and the second MCVideo device 102b are members of the same ProSe Discovery group and are ProSe 1:1 direct communication capable.

3. The first MCVideo device 102a has discovered the second MCVideo device 102b in proximity, using ProSe Discovery procedures.

At step 402, the first MCVideo device 102a sends a Private communication request towards the second MCVideo device 102b. The Private communication request includes a video pull indication and indicates the first MCVideo device 102a as the intended recipient of the video pull. The Private communication request contains the SDP offer.

At step 404, the MCVideo client at the second MCVideo device 102b notifies the MCVideo user of the second MCVideo device 102b about the incoming video pull request.

At step 406, the second MCVideo device 102b automatically accepts the video pull request, and sends a Private communication answer response indicating the acceptance of the video pull request. The Private communication answer response contains SDP answer. It should be noted that the steps 404 and 406 can occur in any order.

At step 408, the MCVideo client at the first MCVideo device 102a notifies the MCVideo user about the incoming Private communication answer response as an indication of acceptance of MCVideo video pull request.

At step 410, the first MCVideo device and the second MCVideo device establish the media plane for communication. In case when the MCVideo device (i.e., either first MCVideo device 102a or the second MCVideo device 102b) fails to establish the communication, then the associated MCVideo client should send a Private communication failed response indicating the failure reason to the appropriate MCVideo client.

At step 412, the video (i.e., media) is transmitted from the second MCVideo device 102b to the first MCVideo device 102a and presented to the first MCVideo device.

If a Private communication failed response is received by the MCVideo device (i.e., either first MCVideo device 102a or the second MCVideo device 102b), before or after establishing the media session, if already established, the session is terminated and the MCVideo user is notified about the failure and its reason.

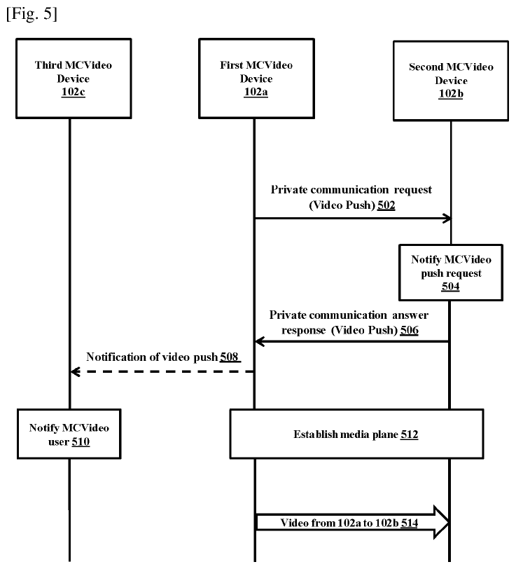

FIG. 5 is a sequence diagram illustrating various signaling messages exchanged between the first MCVideo device, the second MCVideo device and a third MCVideo device, where the first MCVideo device is pushing a video towards the second MCVideo device, according to an embodiment as disclosed herein.

The FIG. 5 describes describes procedures for the off-network MCVideo video push, initiated by the first MCVideo device 102a with the second MCVideo device, to push a video received from the third MCVideo device 102c to the second MCVideo device 102b.

The third MCVideo device 102c or the second MCVideo device 102b or both can be autonomous MCVideo clients or can be human controlled MCVideo clients. In any such combination, following procedure is followed. Further, the third MCVideo device 102c and the first MCVideo device 102a may belong to the same MCVideo user.

The following are the pre-conditions for the the off-network MCVideo video push.

1. The third MCVideo device 102c and the first MCVideo device 102a are engaged in MCVideo communication, where the first MCVideo device 102a is receiving media from the third MCVideo device 102c.

2. The user of the first MCVideo device 102a has initiated MCVideo video push with the MCVideo user of the second MCVideo device 102b.

3. The first MCVideo device 102a and the second MCVideo device 102b are members of the same ProSe Discovery group and are ProSe 1:1 direct communication capable.

4. The first MCVideo device 102a has discovered the second MCVideo device 102b in proximity, associated with the second MCVideo device 102b, using ProSe Discovery procedures.

At step 502, The first MCVideo device 102a sends a Private communication request towards the second MCVideo device 102b. The Private communication request indicates that the request is for video push and contains the SDP offer.

At step 504, the MCVideo client on the second MCVideo device 102b may notify the MCVideo user about the MCVideo Push request (if the second MCVideo device 102b is human controlled).

At step 506, the second MCVideo device 102b automatically accepts the Private communication request for video push and sends a Private communication answer response to the first MCVideo device 102a. The Private communication answer response contains SDP answer. It should be noted that the steps 504 and 506 can occur in any order.

At step 508, if configured, the first MCVideo device 102a notifies the third MCVideo device 102c about the video being pushed to the second MCVideo device 102b by sending a notification message to the third MCVideo device 102b.

At step 510, if configured, the MCVideo client of the third MCVideo device 102c may notify the MCVideo user about the video being pushed to the second MCVideo device 102b.

At step 512, the first MCVideo device 102a and the second MCVideo device 102b establish the media plane for communication.

At step 514, the video which is being received by the first MCVideo device 102a from the third MCVideo device 102c is transmitted from the first MCVideo device 102a to the second MCVideo device 102b and presented to the MCVideo user of the second MCVideo device 102b.

If any MCVideo device fails to establish the communication, the MCVideo client should send a Private communication failed response indicating the failure reason to the appropriate MCVideo client(s).

If a Private communication failed response is received by any MCVideo device, before or after establishing the media session, if already established, the session is terminated and the MCVideo user is notified about the failure and its reason.

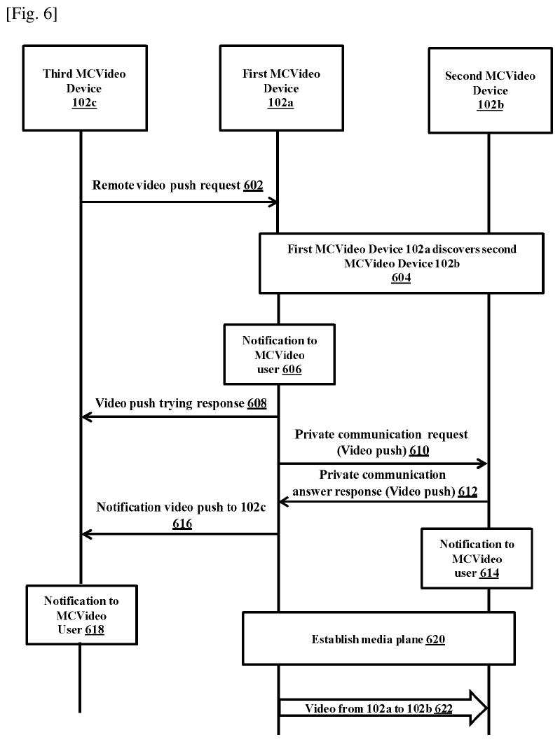

FIG. 6 is a sequence diagram illustrating various signaling messages exchanged between the first MCVideo device, the second MCVideo device and the third MCVideo device, where the first MCVideo device is pushing a video towards the second MCVideo device based on a request from the third MCVideo device, according to an embodiment as disclosed herein.

The FIG. 6 describes procedures for a remotely initiated off-network MCVideo video push, initiated by the MCVideo user at the third MCVideo device 102c with the first MCVideo device 102a, to push a video to the second MCVideo device 102b.

The first MCVideo device 102a can be an autonomous MCVideo device or can be a human controlled MCVideo device.

The following are the pre-conditions for the remotely initiated off-network MCVideo video push.

1. The MCVideo user of the third MCVideo device 102c has remotely initiated MCVideo video push with the first MCVideo device 102a.

2. The third MCVideo device 102c and the first MCVideo device 102a are members of the same ProSe Discovery group and are ProSe 1:1 direct communication capable.

3. The third MCVideo device 102c has discovered the first MCVideo device 102a in proximity using ProSe Discovery procedures.

At step 602, the third MCVideo device 102c sends a remote video push request towards the first MCVideo device 102a. The video push request indicates the second MCVideo device 102b as the intended recipient.

At step 604, the first MCVideo device 102a checks whether there is on-going private communication with the second MCVideo device 102b. If there is on-going private communication with the second MCVideo device 102b, then the step 610, step 612, step 614 and step 616 are skipped, else the first MCVideo device 102a enables ProSe layer to discover the second MCVideo device 102b.

The third MCVideo device 102c may provide the IP address of the the second MCVideo device 102b as part of the remote video push request to the first MCVideo device 102a. In such case, the first MCVideo device 102a does not require discovering the second MCVideo device 102b.

At step 606, the first MCVideo device 102a notifies the user of the first MCVideo device 102a about the incoming video push request (if the first MCVideo device 102a is human controlled).

At step 608, the first MCVideo device 102a sends a video push trying response to the third MCVideo device 102c indicating that it is attempting to establish a connection with the second MCVideo device 102b.

It should be noted that the steps 604, 606 and 608 can occur in any order.

At step 610, once the required details of the second MCVideo device 102b are obtained (either by discovery or from the third MCVideo device 102c), the first MCVideo device 102a B accepts the Video push request, and sends a Private communication request to the second MCVideo device 102b. The Private communication request indicates that the request was in response to the video push request from the the third MCVideo device 102a. The Private communication request contains the SDP offer.

At step 612, the second MCVideo device 102b sends a Private communication answer response to the first MCVideo device 102a in response to the Private communication request. The Private communication answer response contains the SDP answer.

At step 614, the second MCVideo device 102b notifies the MCVideo user about the incoming Private communication request as an indication of incoming video.

It should be noted that the steps 612 and 614 can occur in any order.

At step 616, upon receiving a Private communication answer response from the second MCVideo device 102b, the first MCVideo device 102a sends a notification message to the third MCVideo device 102c indicating that the second MCVideo device 102b has accepted the request.

At step 618, the third MCVideo device 102c notifies the MCVideo user about the acceptance of the request by the second MCVideo device 102b (if the third MCVideo device is human controlled).

At step 620, the first MCVideo device 102a and the second MCVideo device 102b establish the media plane for communication.

If the MCVideo devices 102a and 102b fails to establish the communication, then the respective MCVideo client sends a Private communication failed response indicating the failure reason to the appropriate MCVideo client.

At step 622, the video (i.e., Media) is transmitted from the first MCVideo device 102a to the second MCVideo device 102b and presented to the MCVideo user of the second MCVideo device 102b.

If a Private communication failed response is received by a the first MCVideo device 102a, before or after establishing the media session, if already established, the session is terminated and the MCVideo user is notified about the failure and its reason.

If the first MCVideo device 102a fails to transmit the video to second MCVideo device 102b, then the first MCVideo device 102a sends a notification to the third MCVideo device 102c, indicating the reason.

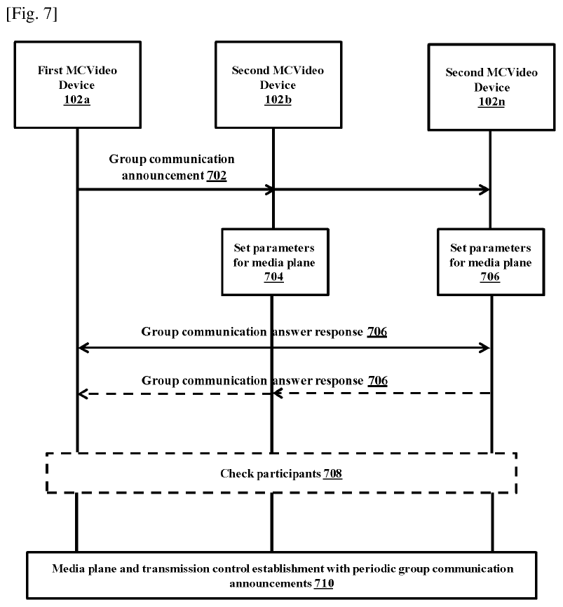

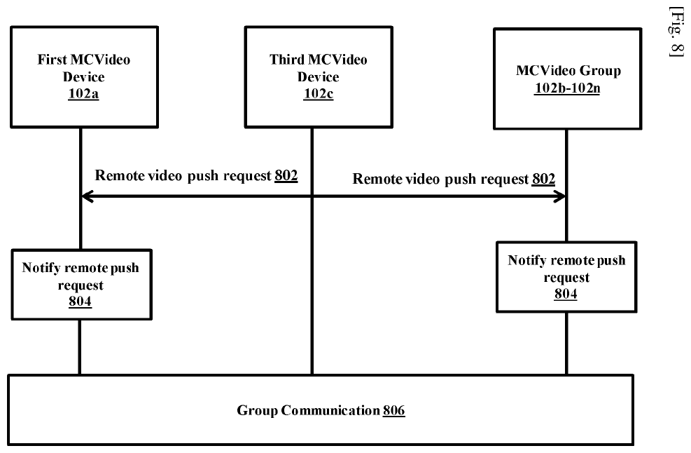

FIG. 7 is a sequence diagram illustrating various signaling messages exchanged between one or more MCVideo devices for MCVideo group communication setup, according to an embodiment as disclosed herein.

The FIG. 7 describes procedures to establish a MCVideo group communication with other MCVideo devices of the MCVideo group. Once the MCVideo group communication is established the MCVideo devices send Group communication announcement periodically.

The following are the pre-conditions for the MCVideo group communication setup.

1. Information for ProSe direct communications corresponding to the MCVideo group and its mapping to ProSe Layer-2 Group ID are pre-configured in the first MCVideo device 102a and the second MC Video devices 102b-102n.

2. The first MCVideo 102a and the second MC Video devices 102b-102n are members of the same MCVideo group.

3. The first MCVideo device 102a has initiated MCVideo group communication.

At step 702, the first MCVideo device 102a sends a Group communication announcement message to the MCVideo group of second MCVideo devices 102b-102n.

At step 704, upon receiving the Group communication announcement message, the second MCVideo devices that are not part of an ongoing group communication for the MCVideo group indicated in the Group communication announcement message set parameters for the media plane as described in the Group communication announcement message.

At step 706, the second MCVideo devices 102b-102n of the MCVideo group send a group communication answer response to the MCVideo group confirming the participation in the MCVideo group communication. On receiving a group communication answer response message from at least one second MCVideo device, other MCVideo devices need not send a group communication answer response message. If the Group communication announcement message included a confirm mode indication, then the MCVideo devices send a group communication answer response message.

The first MCVideo device 102a should wait for at least for one group communication answer response message from one or more second MCVideo devices 102b-102n before transmitting video to the MCVideo group.

At step 708, the first MCVideo device 102a checks the participants of the MCVideo group communication through the received group communication answer response messages.

It should be noted that, due to the movement of the MCVideo devices (in and out of the radio coverage) during the off-network group communication, the group communication announcement message, including parameters for media delivery, is transmitted periodically.

Further, the group communication announcement may include user ID, group ID, media type codec, control port for transmission video, video resolution and video frame rate, video mode, last chage time of video mode or the like.

At step 710, the first MCVideo device 102a, the second MCVideo device 102b and second MCVideo device 102n have successfully established the media plane and transmission control for communication.

FIG. 8 is a sequence diagram illustrating various signaling messages exchanged between the first MCVideo device, the third MCVideo device and a group of second MCVideo devices for pushing the video to the a group of second MCVideo devices, according to an embodiment as disclosed herein.

The FIG. 8 describes procedures for the off-network remote video push request, initiated by the third MCVideo device 102c towards the first MCVideo device 102a, to initiate a video push to MCVideo group of second MCVideo devices 102b-102n.

The following are the pre-conditions for the off-network remote video push to the MCVideo group.

1. The third MCVideo device 102c and the first MCVideo device 102a are members of MCVideo group G.

2. The third MCVideo device 102c has initiated remote video push request with the first MCVideo device 102a to initiate a video push to the MCVideo group G of one or more second MCVideo devices 102b-102n.

At step 802, the third MCVideo device 102c sends a remote video push request towards the MCVideo group of second MCVideo devices 102b-102n and the first MCVideo device 102a. The remote video push request indicates the first MCVideo device 102a as the intended target of the request and MCVideo group of MCVideo devices 102b-102n as the intended recipients.

At step 804, upon receiving the remote video push request as the intended target of the request, the first MCVideo device 102a notifies the MCVideo user of the remote video push request, if the first MCVideo device 102a is human controlled. The other second MCVideo devices of the MCVideo group notify their respective MCVideo users of the remote video push request.

At step 806, the first MCVideo device 102a automatically accepts the remote video push request and sends a group communication announcement message with video push indication towards the MCVideo group. The group communication announcement message contains an SDP body and an indication that the group communication announcement is for the video push. The group communication is established as described in the FIG. 7.

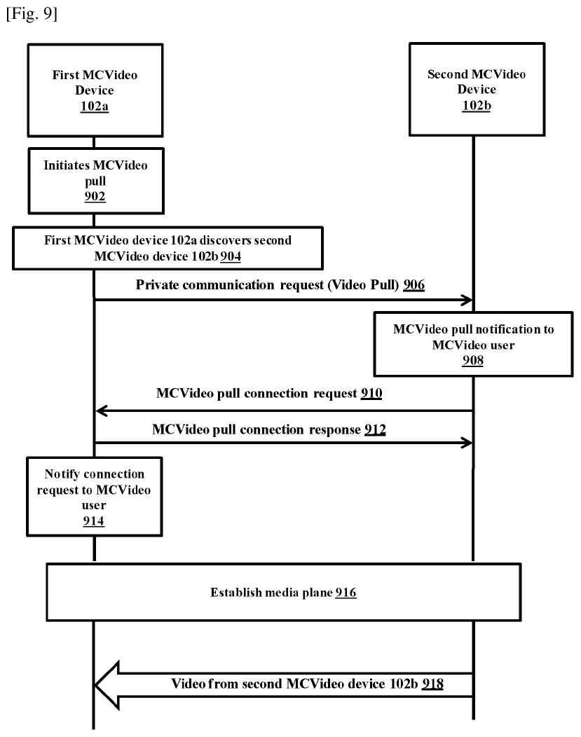

FIG. 9 is a sequence diagram illustrating various signaling messages exchanged between the first MCVideo device and the second MCVideo device, where the first MCVideo device is pulling a video from the second MCVideo device, according to an embodiment as disclosed herein.

The FIG. 9 describes the procedure where the MCVideo user at the first MCVideo device 102a is initiating an off-network MCVideo Pull service with the second MCVideo device 102b. In this procedure, the MCVideo Pull is to pull a video to self (i.e., to the first MCVideo device 102a). The second MCVideo device 102b sends a MCVideo Pull Connection request upon receiving the MCVideo Pull request to which the first MCVideo device responds with MCVideo Pull Connection response. The second MCVideo device 102b can be an autonomous MCVideo device or can be a human controlled MCVideo device. In either case, following procedure is followed as shown in the FIG. 9.

At step 902, the MCVideo user at the first MCVideo device initiates a MCVideo Pull operation directed towards the second MCVideo device 102b (or with the MCVideo user of the second MCVideo device 102b, if the second MCVideo device 102b is human controlled).

At step 904, the first MCVideo device 102a initiates discovery procedures to discover the second MCVideo device 102b. In an embodiment, discovery procedures may initiate ProSe discovery procedures using the ProSe discovery group ID and UserInfoID (or an equivalent ID in case of an autonomous client, for e.g., ClientInfoID) of the MCVideo user of the second MCVideo device 102b as parameters. In an embodiment, ProSe discovery group ID and UserInfoID (or an equivalent ID in case of an autonomous client, for e.g., ClientInfoID) of the second MCVideo device 102b is preconfigured in the first MCVideo device 102a. In another embodiment, the first MCVideo device 102a may initiate MCVideo discovery procedures.

At step 906, the first MCVideo device 102a sends a MCVideo Pull request towards the second MCVideo device 102b. The MCVideo Pull request indicates the first MCVideo device 102a as the intended recipient along with the requested video details. The MCVideo pull request may contain an SDP body. The Requested video can be a video stored on the second MCVideo device 102b or a video captured live by the second MCVideo device 102b.

At step 908, the second MCVideo device 102b notifies the MCVideo user about the incoming MCVideo Pull request if the second MCVideo device 102b is human controlled.

At step 910, the second MCVideo device 102b automatically accepts the MCVideo Pull request, and sends a MCVideo Pull Connection request to the first MCVideo device 102a, indicating the acceptance of the MCVideo Pull request. The MCVideo Pull Connection request contains an SDP offer. It should be noted that the step 908 and step 910 can occur in any order.

At step 912, the first MCVideo device 102a sends a MCVideo Pull Connection response to the second MCVideo device 102b in response to the MCVideo Pull Connection request. The MCVideo Pull Connection request contains an SDP answer.

At step 914, the MCVideo client of the first MCVideo device 102a notifies the MCVideo user about the incoming MCVideo Pull Connection request as an indication of MCVideo Pull request acceptance. It should be noted that the step 912 and step 914 can occur in any order.

At step 916, the first MCVideo device 102a and the second MCVideo device 102b establish the media plane for communication. In case when either of the MCVideo devices 102a or 102b fail to establish the communication due to several reasons like, resource crunch, unsupported media codecs, memory failure etc. In such a situation, the appropriate MCVideo client sends a MCVideo Failed response indicating the failure reason to the other MCVideo client. In an embodiment, the MCVideo device may send the MCVideo Pull Failed response before (or without) sending the MCVideo Pull Answer response.

At step 918, video (i.e., media) is transmitted from the second MCVideo device 102b to the first MCVideo device 102a and presented to the MCVideo user of the first MCVideo device 102a. In an embodiment, if a MCVideo Pull Failed response is received by a MCVideo client before or after the media session establishment, it is automatically terminated and MCVideo user is notified about the failure and its reason.

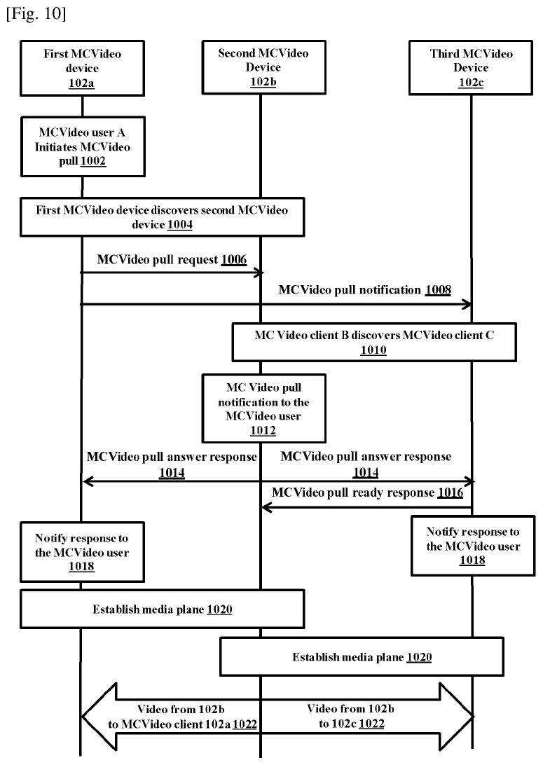

FIG. 10 is a sequence diagram illustrating various signaling messages exchanged between the first MCVideo device, the second MCVideo device and the third MCVideo device, where the first MCVideo device is pulling a video towards itself and the third MCVideo device from the second MCVideo device, according to an embodiment as disclosed herein.

The FIG. 10 describes the procedure where the MCVideo user at the first MCVideo device 102a is initiating an off-network MCVideo Pull service with the second MCVideo device 102b. In this procedure, the MCVideo Pull is to pull a video to self and to another MCVideo device. The second MCVideo device 102b can be an autonomous MCVideo device or can be a human controlled MCVideo device. In either case, the following procedure is followed as shown in the FIG. 10.

At step 1002, the MCVideo user at the first MCVideo device 102a initiates a MCVideo Pull operation directed towards the second MCVideo device 102b.

At step 1004, the first MCVideo device 102a initiates discovery procedures to discover the second MCVideo device 102b. In an embodiment, discovery procedures may initiate ProSe discovery procedures using the ProSe discovery group ID and UserInfoID (or an equivalent ID in case of an autonomous client, for e.g., ClientInfoID) of the MCVideo user B as parameters. In an embodiment ProSe discovery group ID and UserInfoID (or an equivalent ID in case of an autonomous client, for e.g., ClientInfoID) of the second MCVideo user device 102b is preconfigured in the first MCVideo device 102a. In another embodiment, the first MCVideo device 102a may initiate MCVideo discovery procedures.

At step 1006, the first MCVideo device 102a sends a MCVideo Pull request towards the second MCVideo device 102b. The MCVideo Pull request indicates first MCVideo device 102a and the third MCVideo client C as the intended recipients along with the requested video details. MCVideo request may contain an SDP body. Requested video can be a video stored on the second MCVideo device 102b or a video captured live by the second MCVideo device 102b.

At step 1008, the first MCVideo device 102a sends a MCVideo Pull Notification towards the third MCVideo client C about the MCVideo Pull request. The MCVideo Pull Notification may contain an SDP body.

At step 1010, the second MCVideo device 102b initiates discovery procedures to discover the third MCVideo device 102c. In an embodiment, discovery procedures may initiate ProSe discovery procedures using the ProSe discovery group ID and UserInfoID (or an equivalent ID in case of an autonomous client, for e.g., ClientInfoID) of the third MCVideo device 102c as parameters. In an embodiment ProSe discovery group ID and UserInfoID (or an equivalent ID in case of an autonomous client, for e.g., ClientInfoID) of the second MCVideo device 102b is preconfigured in the MCVideo client of the second MCVideo device 102b. In another embodiment, the second MCVideo device 102b may initiate MCVideo discovery procedures. In another embodiment, the first MCVideo device 102a may provide required details about the third MCVideo device 102c as part of the MCVideo Pull request to the second MCVideo device 102b. In such case, the second MCVideo device 102b does not require to discover the third MCVideo device 102c.

At step 1012, the second MCVideo device 102b notifies the MCVideo user about the incoming MCVideo Pull request if the second MCVideo device 102b is human controlled. The Step 1010 and step 1012 can occur in any order.

At step 1014, when the required details of the third MCVideo device 102c are obtained (either by discovery or from the first MCVideo device 102a) the second MCVideo device 102b automatically accepts the MCVideo Pull request, and sends an MCVideo Pull Answer response indicating the acceptance of the MCVideo Pull request to both the first MCVideo device 102a and the third MCVideo device 102c. The MCVideo Pull Answer responses may contain an SDP body.

At step 1016, after receiving the MCVideo Pull Answer response from the second MCVideo device 102b, the third MCVideo device 102c responds with a MCVideo Pull Ready response, once the MC Video client is ready to establish the media plane.

At step 1018, the first MCVideo device 102a and the second MCVideo device 102b notify respective MCVideo users about the incoming MCVideo Pull Answer response as an indication of MCVideo Pull request acceptance. It should be noted that the step 1016 and step 1018 can occur in any order.

At step 1020, the first MCVideo device 102a and the second MCVideo device 102b establish the media plane for communication. Further, the second MCVideo device 102b and the third MCVideo device 102c establish the media plane for communication In some situation, the MCVideo devices 102a-102c may fail to establish the communication due to several reasons like, resource crunch, unsupported media codecs, memory failure etc. In such a situation, the MCVideo client on the MCVideo device sends a MCVideo Failed response indicating the failure reason to the appropriate MCVideo client. In an embodiment MCVideo client may send the MCVideo Pull Failed response before (or without) sending the MCVideo Pull Answer response.

At step 1022, video (i.e., media) is transmitted from the second MCVideo device 102b to the first MCVideo device 102a and the third MCVideo device 102c and presented to the MCVideo users. In an embodiment, if a MCVideo Pull Failed response is received by MCVideo client before or after establishing the media session, it is automatically terminated and MCVideo user is notified about the failure and its reason.

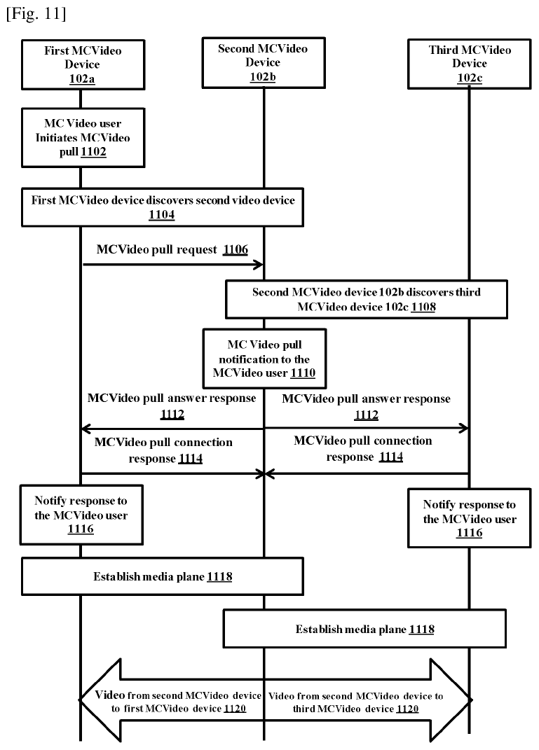

FIG. 11 is another sequence diagram illustrating various signaling messages exchanged between the first MCVideo device 102a, the second MCVideo device 102b and the third MCVideo device 102c, where the first MCVideo device 102a is pulling a video towards itself and the third MCVideo device 102 pulls the video from the second MCVideo device 102b, according to an embodiment as disclosed herein.

The FIG. 11 describes procedure where a MCVideo user at the first MCVideo device 102a initiates an off-network MCVideo Pull service with the second MCVideo device 102b. In this procedure, the MCVideo Pull is to pull a video to self and to third MCVideo device 102c. The second MCVideo client 102b sends a MCVideo Pull Connection request upon receiving the MCVideo Pull request to which the first MCVideo device 102a responds with a MCVideo Pull Connection response. The second MCVideo device 102b can be an autonomous MCVideo device or can be a human controlled MCVideo device. In either case, following procedure should be followed as shown in the FIG. 11.

At step 1102: The MCVideo user A at the first MCVideo device 102a initiates a MCVideo Pull operation directed towards the second MCVideo device 102b (or the MCVideo user B, if the second MCVideo device 102b is human controlled).

At step 1104: the first MCVideo device 102a initiates discovery procedures to discover the second MCVideo client 102b. In an embodiment, discovery procedures may initiate ProSe discovery procedures using the ProSe discovery group ID and UserInfoID (or an equivalent ID in case of an autonomous client, for e.g., ClientInfoID) of the second MCVideo device 102b as parameters. In an embodiment ProSe discovery group ID and UserInfoID (or an equivalent ID in case of an autonomous client, for e.g., ClientInfoID) of MCVideo user B is preconfigured in the first MCVideo device 102a. In another embodiment, the first MCVideo device 102a may initiate MCVideo discovery procedures.

At step 1106: The first MCVideo device 102a sends a MCVideo Pull request towards the second MCVideo device 102b. The MCVideo Pull request indicates the first MCVideo device 102a and the third MCVideo device 102c as the intended recipients along with the requested video details. The MCVideo request may contain an SDP body. Requested video can be a video stored on the second MCVideo device 102b or a video captured live by the second MCVideo device 102b.

At step 1108: The second MCVideo device 102b initiates discovery procedures to discover third MCVideo device 102c. In an embodiment, discovery procedures may initiate ProSe discovery procedures using the ProSe discovery group ID and UserInfoID (or an equivalent ID in case of an autonomous client, for e.g., ClientInfoID) of the MCVideo user C (of the third MCVideo device 102c) as parameters. In an embodiment ProSe discovery group ID and UserInfoID (or an equivalent ID in case of an autonomous client, for e.g., ClientInfoID) of MCVideo user C is preconfigured in the second MCVideo device 102b. In another embodiment, the second MCVideo device 102b may initiate MCVideo discovery procedures. In another embodiment the first MCVideo device 102a may provide required details about the third MCVideo device 102c as part of the MCVideo Pull request to the second MCVideo device 102b. In such case, the second MCVideo device 102b does not require discovering the third MCVideo device 102c.

At step 1110: The second MCVideo device 102b notifies the MCVideo user B about the incoming MCVideo Pull request if the second MCVideo device 102b is human controlled. It should be noted that the step 1108 and step 1110 can occur in any order.

At step 1112: Once the required details of the third MCVideo device 102c are obtained (either by discovery or from MCVideo client),the second MCVideo device 102b automatically accepts the MCVideo Pull request, and sends an MCVideo Pull Connection request to the first MCVideo device 102a and the third MCVideo device 102c, indicating the acceptance of the MCVideo Pull request. The MCVideo Pull Connection request contains an SDP offer.

At step 1114: the first MCVideo device 102a and the third MCVideo device 102c send a MCVideo Pull connection response to second MCVideo device 102b in response to the respective MCVideo Pull connection requests. The MCVideo Pull Connection requests contain an SDP answer.

At step 1116: The first MCVideo device 102a and third MCVideo device 102c notify respective MCVideo users about the incoming MCVideo Pull Connection request as an indication of MCVideo Pull request acceptance.

At step 1118: The first MCVideo device 102a and the second MCVideo device 102b establishes the media plane for communication and the second MCVideo device 102b and the third MCVideo device 102c establishes the media plane for communication In some cases, the MCVideo devices 102a, 102b and 102c may fail to establish the communication due to several reasons like, resource crunch, unsupported media codecs, memory failure etc. In such a situation, the corresponding MCVideo client sends a MCVideo Failed response indicating the failure reason to the appropriate MCVideo client. In an embodiment MCVideo client may send the MCVideo Pull Failed response before (or without) sending the MCVideo Pull Answer response.

At step 1120: Video (i.e., media) is transmitted from the second MCVideo device 102b to the first MCVideo device 102a and the third MCVideo device 102c and presented to the respective MCVideo users. In an embodiment, if MCVideo Pull Failed response is received by the MCVideo client before or after the media session establishment, it is automatically terminated and MCVideo user is notified about the failure and its reason, if any.

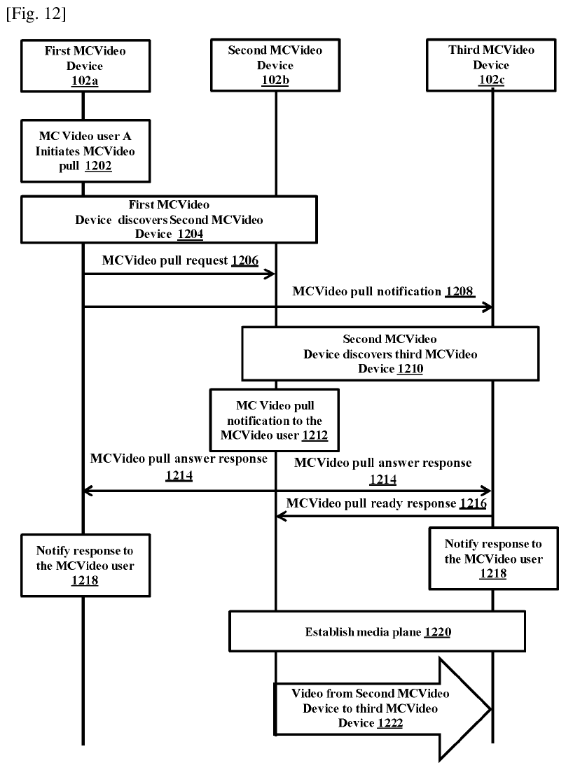

FIG. 12 is a sequence diagram illustrating various signaling messages exchanged between the first MCVideo device, the second MCVideo device and the third MCVideo device, where the first MCVideo device is pulling a video towards itself and the third MCVideo device is pulling the video from the second MCVideo device, according to an embodiment as disclosed herein.

The FIG. 12 describes procedure where the first MCVideo device 102a is initiating an off-network MCVideo Pull service with the second MCVideo device 102b. In this procedure, the MCVideo Pull is to pull a video only to the third MCVideo device 102c. The second MCVideo device 102b B can be an autonomous MCVideo device or can be a human controlled MCVideo device. In either case, following procedure is followed as shown in the FIG. 12.

At step 1202: The MCVideo user A at the first MCVideo device 102a initiates a MCVideo Pull operation directed towards the second MCVideo device 102b (or MCVideo user B, if the second MCVideo device is human controlled).

At step 1204: The first MCVideo device 102a initiates discovery procedures to discover second MCVideo device 102b. In an embodiment, discovery procedures may initiate ProSe discovery procedures using the ProSe discovery group ID and UserInfoID (or an equivalent ID in case of an autonomous client, for e.g., ClientInfoID) of the MCVideo user B as parameters. In an embodiment ProSe discovery group ID and UserInfoID (or an equivalent ID in case of an autonomous client, for e.g., ClientInfoID) of MCVideo user B is preconfigured in MCVideo client A. In another embodiment, first MCVideo device 102a may initiate MCVideo discovery procedures.

At step 1206: The first MCVideo device 102a sends a MCVideo Pull request towards the second MCVideo device 102b. The MCVideo Pull request indicates third MCVideo device 102c as the intended recipient along with the requested video details. The MCVideo request may contain an SDP body. Requested video can be a video stored on the second MCVideo device 102b or a video captured live by the second MCVideo device 102b.

At step 1208: The first MCVideo device 102a sends a MCVideo Pull notification towards the third MCVideo device 102c about the MCVideo Pull request. The MCVideo Pull Notification may contain an SDP body.

At step 1210: the second MCVideo device 102b initiates discovery procedures to discover the third MCVideo device 102c. In an embodiment, discovery procedures may initiate ProSe discovery procedures using the ProSe discovery group ID and UserInfoID (or an equivalent ID in case of an autonomous client, for e.g., ClientInfoID) of the MCVideo user C as parameters. In an embodiment ProSe discovery group ID and UserInfoID (or an equivalent ID in case of an autonomous client, for e.g., ClientInfoID) of MCVideo user is preconfigured in the second MCVideo device 102b. In another embodiment, the second MCVideo device 102b may initiate MCVideo discovery procedures. In another embodiment, the first MCVideo device 102a may provide required details about the third MCVideo device 102c as part of the MCVideo Pull request to the MCVideo client. In such case, the second MCVideo device 102b does not require discovering the third MCVideo device 102c.

At step 1212: The second MCVideo device 102b notifies the MCVideo user about the incoming MCVideo pull request if the second MCVideo device 102b is human controlled.

At step 1214: Once the required details of the third MCVideo device 102c are obtained (either by discovery or from MCVideo client A) the second MCVideo device 102b automatically accepts the MCVideo Pull request, and sends the MCVideo Pull Answer response indicating the acceptance of the MCVideo Pull request to the first MCVideo device 102a and the third MCVideo device 102c. The MCVideo Pull Answer responses may contain an SDP body.

At step 1216: Upon receiving a MCVideo Pull Answer response from the second MCVideo device 102b, the third MCVideo device 102c responds with a MCVideo Pull Ready response, once the client is ready to establish the media plane.

At step 1218: The First MCVideo device 102a and the third MCVideo device 102c notify respective MCVideo users about the incoming MCVideo Pull Answer response as an indication of MCVideo Pull request acceptance. It should be noted that the step 1216 and step 1218 can occur in any order.

At step 1220: The second MCVideo device 102b and the third MCVideo device 102c establish the media plane for communication. The MCVideo devices 102b and 102c may fail to establish the communication due to several reasons like, resource crunch, unsupported media codecs, memory failure etc. In such a situation, the corresponding MCVideo client sends a MCVideo Failed response indicating the failure reason to the appropriate MCVideo client. In an embodiment, MCVideo client may send the MCVideo Pull Failed response before (or without) sending the MCVideo Pull Answer response.

At step 1222: video (i.e., media) is transmitted from second MCVideo device 102b Third MCVideo device 102c and presented to the MCVideo user. In an embodiment, if a MCVideo Pull Failed response is received by the second MCVideo device 102b before or after establishing the media session, it is automatically terminated and MCVideo user is notified about the failure and its reason, if any.

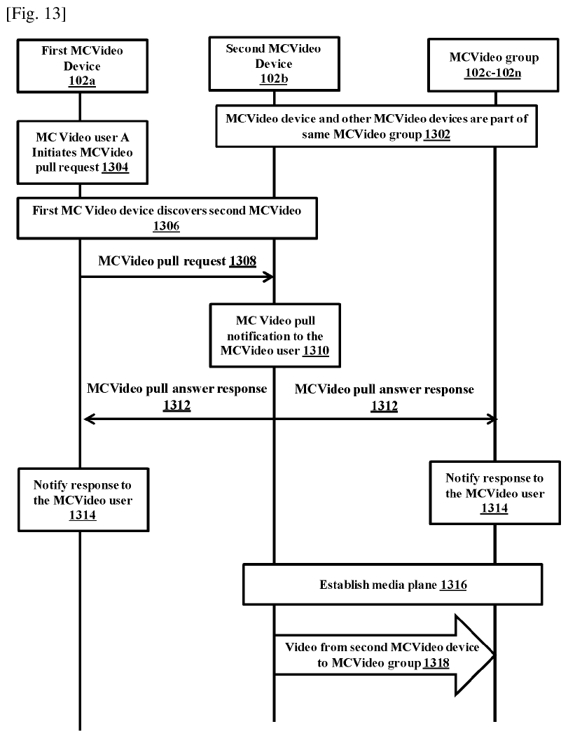

FIG. 13 is a sequence diagram illustrating various signaling messages exchanged between the first MCVideo device, the second MCVideo device and a MCVideo group, where the first MCVideo device is pulling a video towards the MCVideo group from the second MCVideo device, according to an embodiment as disclosed herein.

The FIG. 13 describes procedure where a MCVideo user A at the first MCVideo device 102a is initiating an off-network MCVideo Pull service with second MCVideo device 102b. In this procedure, the MCVideo Pull is to pull a video to a MCVideo group. The first MCVideo device 102a is not a member of the MCVideo group. The second MCVideo device 102b can be an autonomous MCVideo device or can be a human controlled MCVideo device. In either case, following procedure is followed as shown in the FIG. 13.

At step 1302: The second MCVideo device 102b and other MCVideo devices 102c-102n, except the first MCVideo device 102a are associated to the same MCVideo group.

At step 1304: The MCVideo user A at the first MCVideo device 102a initiates a MCVideo Pull operation directed towards the second MCVideo device (or MCVideo user B, if the second MCVideo device 102b is human controlled).

At step 1306: The first MCVideo device 102a initiates discovery procedures to discover the second MCVideo device 102b. In an embodiment, discovery procedures may initiate ProSe discovery procedures using the ProSe discovery group ID and UserInfoID (or an equivalent ID in case of an autonomous client, for e.g., ClientInfoID) of the MCVideo user B as parameters. In an embodiment ProSe discovery group ID and UserInfoID (or an equivalent ID in case of an autonomous client, for e.g., ClientInfoID) of MCVideo user B is preconfigured in the first MCVideo device 102a. In another embodiment, the first MCVideo device 102a may initiate MCVideo discovery procedures.

At step 1308: The first MCVideo device 102a sends a MCVideo Pull request towards the second MCVideo device 102b. The MCVideo Pull request indicates MCVideo group of MCVideo devices 102c-102n as the intended recipient along with the requested video details.

At step 1310: The second MCVideo device 102b notifies the MCVideo user B about the MCVideo Pull request, if the MCVideo client B is a human controlled MCVideo client.

At step 1312: The second MCVideo device 102b automatically accepts the MCVideo Pull request and broadcasts/multicasts a MCVideo Pull Notification response towards the MCVideo group and a MCVideo Pull Answer response towards the first MCVideo device 102a. The MCVideo Pull Notification response may contain an SDP body. It should be noted that the step 1310 and the step 1312 can occur in any order.

At step 1314: Upon receiving the MCVideo Pull Answer response, the first MCVideo device 102a notifies the MCVideo user A of the acceptance of the MCVideo pull request, if the MCVideo client A is human controlled. The MCVideo group members also notify their respective MCVideo users of the incoming communication on receiving the MCVideo Pull Notification response.

At step 1316: The second MCVideo device 102b establishes the media plane for communication with the MCVideo group. The second MCVideo device 102b may fail to establish the communication due to several reasons like, resource crunch, unsupported media codecs, memory failure etc. In such a situation, the second MCVideo device 102b broadcasts a MCVideo Failed response indicating the failure reason to the MCVideo group members. In an embodiment, the second MCVideo device 102b may send the MCVideo Pull Failed response before (or without) sending the MCVideo Pull Answer response or MCVideo Pull Notification response.

At step 1318: the second MCVideo device 102b broadcasts/multicasts media towards the MCVideo group 102c-102n; which is presented to the respective MCVideo group members. In an embodiment, if a MCVideo Pull Failed response is received by MCVideo device before or after establishing the media session, it is automatically terminated and the MCVideo user is notified about the failure and its reason, if any.

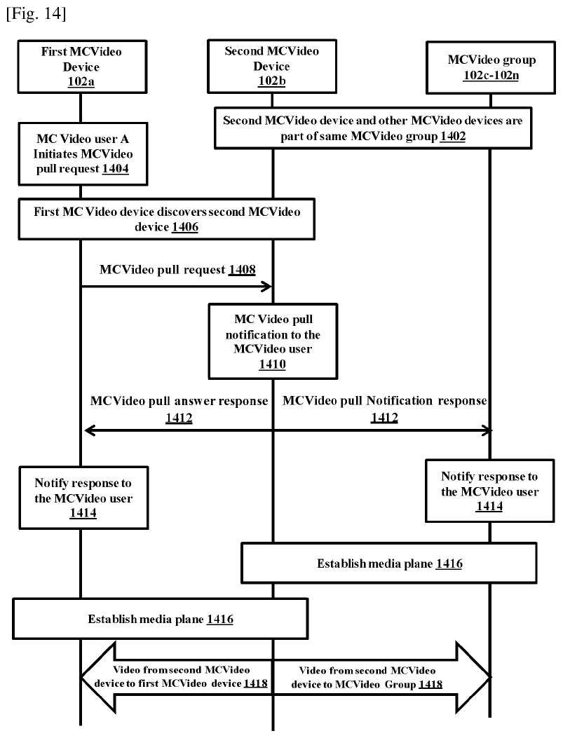

FIG. 14 is a sequence diagram illustrating various signaling messages exchanged between the first MCVideo device 102a, the second MCVideo device 102b and the MCVideo group 102c-102n, where the first MCVideo device is pulling a video towards itself and the MCVideo group from the second MCVideo device, according to an embodiment as disclosed herein.

The FIG. 14 describes procedure where a MCVideo user A at the first MCVideo device 102a is initiating an off-network MCVideo Pull service with the second MCVideo device 102b. In this procedure, the MCVideo Pull is to pull a video to itself and the MCVideo group of MCVideo devices 102c-102n. The first MCVideo device 102a is not a member of the MCVideo group. The second MCVideo device 102b can be an autonomous MCVideo device or can be a human controlled MCVideo device. In either case, following procedure is followed.

At step 1402: The second MCVideo device 102b and other MCVideo devices 102c-102n, except the first MCVideo device 102a are associated to the same MCVideo group.

At step 1404: The MCVideo user A at the first MCVideo device 102a initiates a MCVideo Pull operation directed towards the second MCVideo device 102b (or the MCVideo user B, if the MCVideo client at the second MCVideo device 102b is human controlled).

At step 1406: The first MCVideo device 102a initiates discovery procedures to discover the second MCVideo device 102b. In an embodiment, discovery procedures may initiate ProSe discovery procedures using the ProSe discovery group ID and UserInfoID (or an equivalent ID in case of an autonomous client, for e.g., ClientInfoID) of the MCVideo user B as parameters. In an embodiment ProSe discovery group ID and UserInfoID (or an equivalent ID in case of an autonomous client, for e.g., ClientInfoID) of MCVideo user B is preconfigured in the first MCVideo device 102a. In another embodiment, the first MCVideo device 102a may initiate MCVideo discovery procedures.

At step 1408: The first MCVideo device 102a sends a MCVideo Pull request towards the MCVideo client B. The MCVideo Pull request indicates the first MCVideo device 102a and the MCVideo group of MCVideo devices 102c-102n as the intended recipients along with the requested video details. The MCVideo Pull request may contain a SDP body.

At step 1410: The second MCVideo device 102b notifies the MCVideo user B about the MCVideo Pull request, if the MCVideo client at the second MCVideo device 102b is a human controlled MCVideo client.

At step 1412: The second MCVideo device 102b automatically accepts the MCVideo Pull request and broadcasts/multicasts a MCVideo Pull Notification response towards the MCVideo group and a MCVideo Pull Answer response towards the first MCVideo device 10a. MCVideo Pull Notification response and MCVideo Answer response, both may contain an SDP body each. It should be noted that the step 1410 and 1412 can occur in any order.

At step 1414: Upon receiving the MCVideo Pull Answer response, the first MCVideo device 102a notifies the MCVideo user A of the acceptance of the MCVideo pull request, if the MCVideo client A is human controlled. The MCVideo group members also notify their respective MCVideo users of the incoming communication on receiving the MCVideo Pull Notification response.

At step 1416: The second MCVideo device 102b establishes a media plane for communication with the first MCVideo 102a. Further, the second MCVideo device 102b establishes another media plane for communication with the MCVideo group. The first MCVideo device 102a or the second MCVideo device 102b may fail to establish the communication due to several reasons like, resource crunch, unsupported media codecs, memory failure etc. In such a situation, the corresponding MCVideo client sends a MCVideo Failed response indicating the failure reason to appropriate MCVideo clients. In an embodiment, the MCVideo client may send the MCVideo Pull Failed response before (or without) sending the MCVideo Pull Answer response or MCVideo Pull Notification response.

At step 1418: The second MCVideo device 102b sends video (i.e., media) towards the first MCVideo device 102a and broadcasts/multicasts media towards the MCVideo group members; which is presented to the respective MCVideo group members. In an embodiment, if a MCVideo Pull Failed response is received by the MCVideo client before or after establishing the media session, it is automatically terminated and MCVideo user is notified about the failure and its reason, if any.

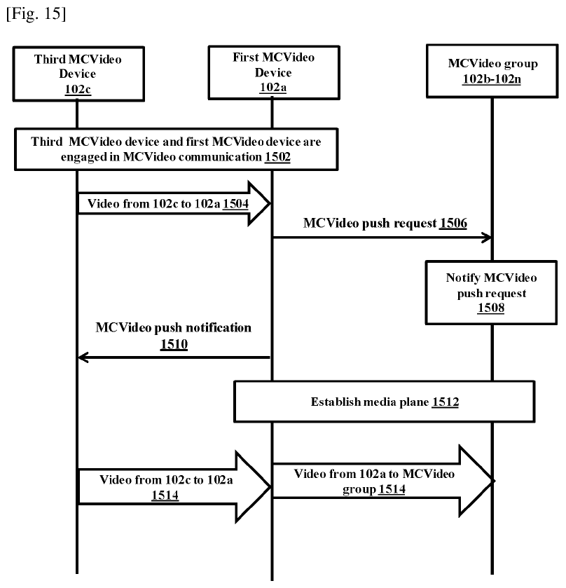

FIG. 15 is a sequence diagram illustrating various signaling messages exchanged between the first MCVideo device, the second MCVideo device and the MCVideo group, where the first MCVideo device is pushing a video towards MCVideo group, according to an embodiment as disclosed herein.

The FIG. 15 describes procedure where a MCVideo user B at the second MCVideo device 102b is pushing a video to MCVideo group by initiating an off-network MCVideo Push service. In this procedure, the MCVideo Push is to push a video to which is received by the first MCVideo device 102a from the third MCVideo device 102a. The first MCVideo device 102a can be autonomous MCVideo devices or can be human controlled MCVideo devices. In any such combination, following procedure should be followed. The first MCVideo device 102a belongs to the MCVideo group to which the video is being pushed. The third MCVideo device 102c may or may not be part of the MCVideo group of MCVideo devices 102b-102n. In a particular embodiment, the third MCVideo device 102c and the first MCVideo device 102a belong to the same MCVideo user. In another embodiment, the third MCVideo device 102c and the first MCVideo device 102a are the same clients (single client). The third MCVideo device 102c and the first MCVideo device 102a are part of the same ProSe discovery group and are capable of 1:1 ProSe direct communication with each other.

At step 1502: The third MCVideo device 102c and the first MCVideo device 102a are engaged in a private or group communication, where the first MCVideo device 102a is receiving video from the third MCVideo device 102c, as at step 1504. In an embodiment, the third MCVideo device 102c and the first MCVideo device 102a belong to the same MCVideo user.

At step 1506: The MCVideo user at the first MCVideo device initiates a MCVideo Push operation directed towards MCVideo group of MCVideo devices 102b-102n. The MCVideo Push request may contains an SDP body.

At step 1508: The members of the MCVideo group are notified by their respective MCVideo clients about the MCVideo Push request, if the MCVideo clients are human controlled.

At step 1510: If configured, the first MCVideo device 102a notifies the MCVideo client at the first MCVideo device 102a about the video being pushed to the MCVideo group. In an embodiment, if MCVideo client A and MCVideo client B are a single entity, the notification is presented to the user of the MCVideo client, if the MCVideo client is human controlled.

At step 1512: The first MCVideo device 102a and the MCVideo group of MCVideo devices 102b-102n establish the media plane for communication. The first MCVideo device 102a may fail to establish the communication due to several reasons like, resource crunch, unsupported media codecs, memory failure etc. In such a situation, the corresponding MCVideo client sends a MCVideo Push Failed response indicating the failure reason to the appropriate MCVideo client. In an embodiment, the MCVideo client may send the MCVideo Push Failed response before (or without) sending the MCVideo Push Answer response.

At step 1514: the video (i.e., media) received by the first MCVideo device 102a from the third MCVideo device 102c is transmitted from the first MCVideo device 102a to the MCVideo group and presented to the members of the MCVideo group. In an embodiment, if a MCVideo Push Failed response is received by the first MCVideo device 102a or the MCVideo devices of the MCVideo group, before or after establishing the media session, it is automatically terminated and the MCVideo user is notified about the failure and its reason, if any.

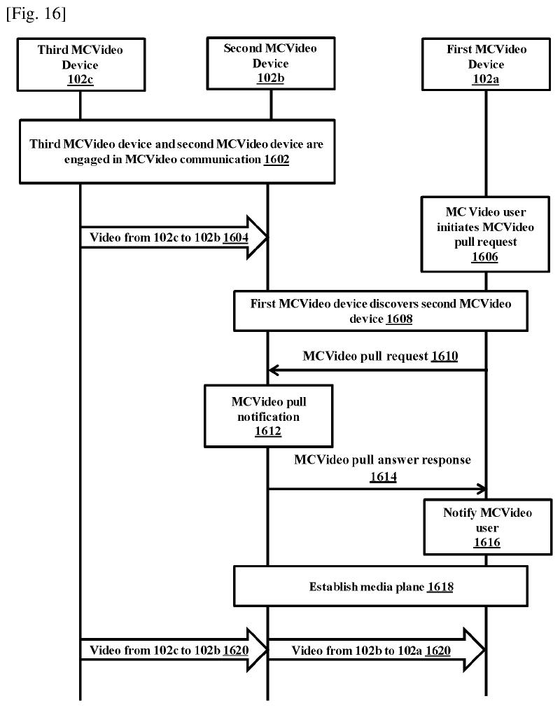

FIG. 16 is a sequence diagram illustrating various signaling messages exchanged between the first MCVideo device 102a, the second MCVideo device 102b and the third MCVideo device 102b, where the second MCVideo device 102b is receiving a video from the third MCVideo device 102b, which is being pulled by the first MCVideo device 102a, according to an embodiment as disclosed herein.

The FIG. 16 describes the procedure where a MCVideo user at the first MCVideo device 102a is initiating an off-network MCVideo Pull service with the second MCVideo device 102b. In this procedure, the MCVideo Pull request from the first MCVideo device 102a is to pull a video to itself, which is being received by the second MCVideo device 102b from the third MCVideo device 102c. The third MCVideo device 102c or the second MCVideo device 102b can be an autonomous MCVideo device or can be a human controlled MCVideo device. In any case, following procedure should be followed as shown in the FIG. 16.

At step 1602: The third MCVideo device 102c and the second MCVideo device 102b are engaged in a MCVideo communication.

At step 1604: A video is being transmitted from the third MCVideo device 102c to the second MCVideo device 102b.

In an embodiment, both the third MCVideo device 102c and the second MCVideo device 102b may belong to the same MCVideo user.

At step 1606: The MCVideo user at the first MCVideo device initiates a MCVideo Pull operation directed towards the second MCVideo device 102b.

At step 1608: The first MCVideo device 102a initiates discovery procedures to discover the second MCVideo device 102b. In an embodiment, discovery procedures may initiate ProSe discovery procedures using the ProSe discovery group ID and UserInfoID (or an equivalent ID in case of an autonomous client, for e.g., ClientInfoID) of the MCVideo user B as parameters. In an embodiment ProSe discovery group ID and UserInfoID (or an equivalent ID in case of an autonomous client, for e.g., ClientInfoID) of MCVideo user B is preconfigured in the first MCVideo device 102a.

At step 1610: The first MCVideo device 102a sends a MCVideo Pull request towards the second MCVideo device 102b. The MCVideo Pull request indicates the first MCVideo device 102a as the intended recipient along with the requested video details (which, in this case, is the video being received from the third MCVideo device 102c). The MCVideo request may contain an SDP body.

At step 1612: The second MCVideo device 102b notifies the MCVideo user B about the incoming MCVideo Pull request if MCVideo client B is human controlled.

At step 1614: The second MCVideo device 102b automatically accepts the MCVideo Pull request, and sends a MCVideo Pull Answer response indicating the acceptance of the MCVideo Pull request. The MCVideo Pull Answer response may contain an SDP body. In an embodiment, Step 5 and step 6 can occur in any order.

At step 1616: The first MCVideo device 102a notifies the MCVideo user A about the incoming MCVideo Pull Answer response as an indication of MCVideo Pull request acceptance.

At step 1618: The second MCVideo device 102b and the first MCVideo device 102c establish the media plane for communication. The MCVideo device 102a or 102b may fail to establish the communication due to several reasons like, resource crunch, unsupported media codecs, memory failure etc. In such a situation, the corresponding MCVideo client sends a MCVideo Failed response indicating the failure reason to the appropriate MCVideo client. In an embodiment, MCVideo client may send the MCVideo Pull Failed response before (or without) sending the MCVideo Pull Answer response.

At step 1620: Video (i.e., Media), which is received from the third MCVideo device 102c, is transmitted from the second MCVideo device 102b to the first MCVideo device 102a and presented to the MCVideo user A of the first MCVideo device 102a. In an embodiment, if a MCVideo Pull Failed response is received by a MCVideo device 102a or 102b before or after receiving establishing the media session, if already established, it is automatically terminated and the MCVideo user is notified about the failure and its reason, if any.

The embodiments disclosed herein can be implemented through at least one software program running on at least one hardware device and performing network management functions to control the elements. The elements shown in the FIGS. 1 through 16 include blocks which can be at least one of a hardware device, or a combination of hardware device and software module.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1.-28. (canceled)

29. A method of performing video communication for an off-network by a first device in a communication system, the method comprising:
transmitting a communication request message comprising a video push request to at least one second device, wherein the first device and the at least one second device are included in a same proximity-based services (ProSe) group;
receiving a communication answer response message from the at least one second device;
establishing media plane communication for video communication with the at least one second device; and
communicating video data with the at least one second device.

30. (canceled)

31. The method of claim 29, wherein the video data is transmitted from the first device to the at least one second device after establishing the media plane communication.

32. The method of claim 29, further comprising:
transmitting a video push notification message to a third device,
wherein the video push notification message indicates that the video data is pushed to the at least one second device.

33. The method of claim 29,
wherein the video data is a video data received by the first device from a third device, and
wherein media plane communication between the first device and the third device is pre-established.

34. The method of claim 29, wherein the communication request message is transmitted to the at least one second device by the first device, in response to a remote video push request message received from a third device.

35. The method of claim 34, further comprising:
transmitting a response message to the third device, in response to the communication request message,
wherein the response message indicates that the first device is trying to establish communication with the at least one second device.

36. The method of claim 34, further comprising:
transmitting a video push notification message to the third device,
wherein the video push notification message indicates that a communication request has been accepted by the at least one second device.

37. The method of claim 29, wherein the communication request message is transmitted periodically.

38. The method of claim 29, wherein the communication request message further comprises session description protocol (SDP) offer, and,
wherein the communication answer response message comprises SDP answer.

39. A first device of performing video communication for an off-network in a communication system, the first device comprising:
a transceiver; and
a processor coupled with the transceiver and configured to:
transmit a communication request message comprising a video push request to at least one second device, wherein the first device and the at least one second device are included in a same proximity-based services (ProSe) group,
receive a communication answer response message from the at least one second device,
establish media plane communication for video communication with the at least one second device, and
communicate video data with the at least one second device.

40. (canceled)

41. The first device of claim 39, wherein the video data is transmitted from the first device to the at least one second device after establishing the media plane communication.

42. The first device of claim 39, wherein the processor is further configured to:
transmit a video push notification message to a third device,
wherein the video push notification message indicates that the video data is pushed to the at least one second device.

43. The first device of claim 39,
wherein the video data is a video data received by the first device from a third device, and
wherein media plane communication between the first device and the third device is pre-established.

44. The first device of claim 39, wherein the communication request message is transmitted to the at least one second device by the first device, in response to a remote video push request message received from a third device.

45. The first device of claim 44, wherein the processor is further configured to:
transmit a response message to the third device, in response to the communication request message,
wherein the response message indicates that the first device is trying to establish communication with the at least one second device.

46.-48. (canceled)

49. A method of performing video communication for an off-network by a fourth device in a communication system, the method comprising:
transmitting a communication request message comprising a video pull request to at least one fifth device, wherein the fourth device and the at least one fifth device are included in a same proximity-based services (ProSe) group;
receiving a communication answer response message, from the at least one fifth device;
establishing media plane communication for video communication with the at least one fifth device; and
communicating video data with the at least one fifth device.

50. The method of claim 49, wherein the video data is transmitted from the at least one fifth device to the fourth device after establishing the media plane communication.

51. The method of claim 49,
wherein the communication request message further comprises session description protocol (SDP) offer, and
wherein the communication answer response message comprises SDP answer.

52. The method of claim 49, further comprising:
performing a ProSe discovery procedure for a discovery of the at least one fifth device in proximity.

53. A fourth device of performing video communication for an off-network in a communication system, the fourth device comprising:
a transceiver; and
a processor coupled with the transceiver and configured to:
transmit a communication request message comprising a video pull request to at least one fifth device, wherein the fourth device and the at least one fifth device are included in a same proximity-based services (ProSe) group,
receive a communication answer response message, from the at least one fifth device,
establish media plane communication for video communication with the at least one fifth device, and
communicate video data with the at least one fifth device.

54. The method of claim 33, wherein the first device in proximity to the third device, is discovered at the third device in a ProSe discovery procedure of the third device.
